(19) United States
(12) Patent Application Publication
(10) Pub. No.: US 2025/0365497 A1
(43) Pub. Date: Nov. 27, 2025

(54) IMAGING APPARATUS, METHOD, AND SYSTEM

(71) Applicant: Panasonic Intellectual Property Management Co., Ltd., Osaka (JP)

(72) Inventors: Takaaki YAMASAKI, Osaka (JP); Shinichi YAMAMOTO, Osaka (JP)

(73) Assignee: Panasonic Intellectual Property Management Co., Ltd., Osaka (JP)

(21) Appl. No.: 19/218,229

(22) Filed: May 24, 2025

(30) Foreign Application Priority Data
May 27, 2024 (JP) 2024-085709

(51) Int. Cl. H04N 23/611; H04N 23/62; H04N 23/667; H04N 23/88

(52) U.S. Cl. CPC H04N 23/611; H04N 23/62; H04N 23/667; H04N 23/88

(57) ABSTRACT

An imaging apparatus includes: an image sensor that captures a subject image to generate a captured image; an image processor that performs image processing on the captured image generated by the image sensor; and a controller that controls image processing by the image processor, based on the captured image, wherein the controller detects a subject being in a predetermined state, from the captured image, and causes the image processor to perform the image processing generating a processed image when the subject in the predetermined state is detected, the processed image having an image effect different between an inside and an outside of a subject region corresponding to the subject in the predetermined state in the captured image.

### TECHNICAL FIELD

The present disclosure relates to an imaging apparatus, a method, and a system that perform image processing on a captured image.

### BACKGROUND ART

Patent Document 1 discloses an imaging apparatus that has an object of enabling, at the time of shooting, color conversion to leave a color freely designated by the user and erase other color components with simple operation. In this imaging apparatus, a designated color of the user is determined based on color information included in a predetermined region of an image being displayed in an electronic viewfinder that displays an image based on image data captured by an image sensor and output from an image processor. Then, the imaging apparatus sets a parameter of the image processor so as to perform color conversion in which a color other than a determined designated color is erased.

### SUMMARY

The present disclosure provides an imaging apparatus, a method, and a system that can facilitate to realize a desired image effect on a captured subject.

In the present disclosure, an imaging apparatus includes an image sensor that captures a subject image to generate a captured image; an image processor that performs image processing on the captured image generated by the image sensor; and a controller that controls image processing by the image processor, based on the captured image, wherein the controller detects a subject being in a predetermined state, from the captured image, and causes the image processor to perform the image processing generating a processed image when the subject in the predetermined state is detected, the processed image having an image effect different between an inside and an outside of a subject region corresponding to the subject in the predetermined state in the captured image.

In the present disclosure, an imaging method includes capturing, by an image sensor, a subject image to generate a captured image; performing, by an image processor, image processing on the captured image generated by the image sensor; and controlling, by a controller, the image processing by the image processor, based on the captured image, wherein the controller detects a subject being in a predetermined state, from the captured image, and causes the image processor to perform the image processing to generate a processed image in response to detecting the subject in the predetermined state, the processed image having an image effect different between an inside and an outside of a subject region corresponding to the subject in the predetermined state in the captured image.

In the present disclosure, an imaging system includes an imaging apparatus and an image processing apparatus wherein the imaging apparatus includes: an image sensor that captures a subject image to generate a captured image; and a transmitter that transmits image data indicating the captured image to the image processing apparatus, the image processing apparatus includes: a receiver that receives the image data from the imaging apparatus; and an image processor that performs, based on the image data received by the receiver, image processing on the captured image indicated by the image data, and the imaging apparatus or the image processing apparatus includes: a controller that detects a subject being in a predetermined state, from the captured image, and causes the image processor to perform the image processing to generate a processed image when the subject in the predetermined state is detected, the processed image having an image effect different between an inside and an outside of a subject region corresponding to the subject in the predetermined state in the captured image.

According to the imaging apparatus, method, and system of the present disclosure, it is possible to facilitate to realize a desired image effect on a captured subject.

### BRIEF DESCRIPTION OF DRAWINGS

FIG. 1 is a diagram for explaining an imaging system according to a first embodiment of the present disclosure;

FIG. 2 is a diagram exemplifying a configuration of a digital camera in the imaging system;

FIG. 3 is a diagram exemplifying a configuration of an image processing server in the imaging system;

FIGS. 4A to 4D are diagrams for explaining operation of the imaging system of the first embodiment;

FIG. 5 is a flowchart exemplifying operation of the digital camera in the imaging system of the first embodiment;

FIG. 6 is a diagram illustrating a data structure of cut allocation information in the imaging system;

FIG. 7 is a diagram for explaining detection operation of a subject region in the imaging system;

FIG. 8 is a flowchart exemplifying automatic editing processing in the imaging system of the first embodiment;

FIGS. 9A and 9B are diagrams for explaining image processing in the imaging system; and

FIG. 10 is a flowchart exemplifying operation of the digital camera in the imaging system of a second embodiment.

### DETAILED DESCRIPTION

Embodiments will be described in detail below with reference to the drawings as appropriate. However, more detailed description than necessary may be omitted. Note that the accompanying drawings and description below are provided to enable those skilled in the art to sufficiently understand the present disclosure, and these are not intended to limit the subject matter described in the claims.

### First Embodiment

### 1. Configuration

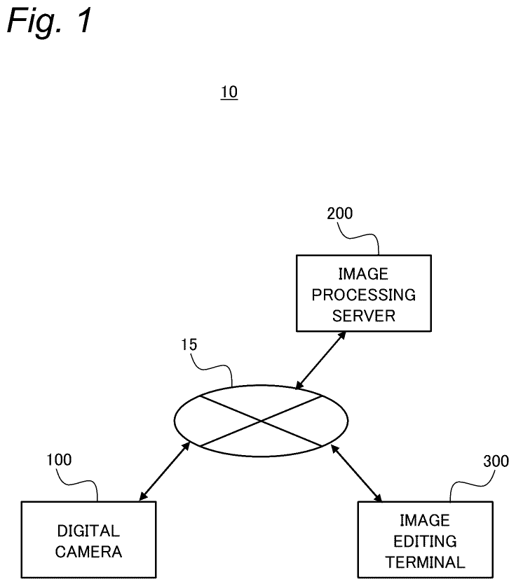

An imaging system according to a first embodiment of the present disclosure will be described with reference to FIG. 1.

As illustrated in FIG. 1, an imaging system 10 according to the present embodiment includes a digital camera 100, an image processing server 200, and an image editing terminal 300, for example. In the present system 10, the image processing server 200 is, for example, a cloud server, data-communicably connected to the digital camera 100 and the image editing terminal 300 via a communication network 15 such as the Internet. The digital camera 100 and the image editing terminal 300 may be connected to each other in a wired or wireless manner in a manner that data communication can be performed.

The present system 10 is applicable to a user creating a desired video work by shooting and editing a plurality of videos with the digital camera 100, for example. For example, the present system 10 provides information support useful for a series of workflows in which a user plans a scenario indicating a concept of a video work, repeatedly shoot a video according to a plurality of cuts that are divided from the scenario, and edits a plurality of shot videos.

The image editing terminal 300 may be various information terminals such as a personal computer (PC), a smartphone, or a tablet terminal. In the present system 10, the image editing terminal 300 may be omitted. Alternatively, the image editing terminal 300 may be an example of an image processing apparatus. The image editing terminal 300 and the image processing server 200 may be integrally configured.

### 1-1. Configuration of Digital Camera

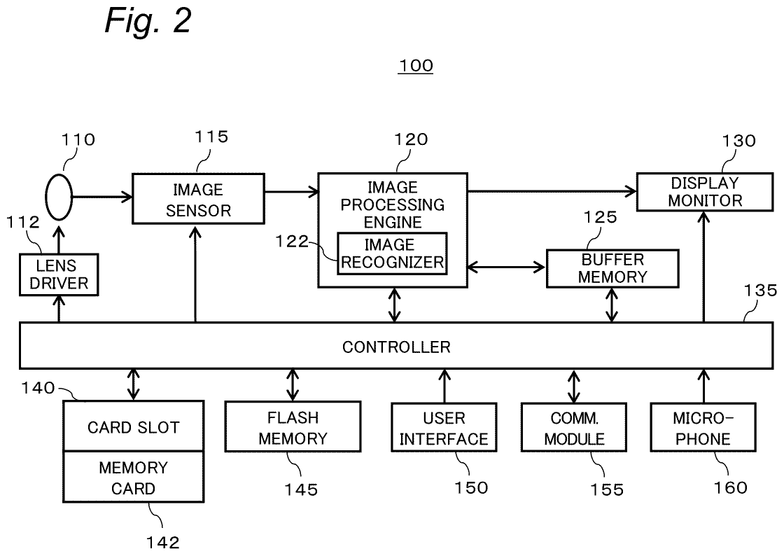

A configuration of the digital camera 100 in the present embodiment will be described with reference to FIG. 2.

FIG. 2 is a diagram illustrating the configuration of the digital camera 100 in the present system 10. The digital camera 100 is an example of an imaging apparatus in the present embodiment. The digital camera 100 according to the present embodiment includes an image sensor 115, an image processing engine 120, a display monitor 130, and a controller 135. Furthermore, the digital camera 100 includes a buffer memory 125, a card slot 140, a flash memory 145, a user interface 150, a communication module 155, and a microphone 160. Furthermore, the digital camera 100 includes an optical system 110 and a lens driver 112, for example.

The optical system 110 includes a focus lens, a zoom lens, an optical image stabilizer (OIS), an aperture, a shutter, and the like. The focus lens is a lens for changing a focus state of a subject image formed on the image sensor 115. The zoom lens is a lens for changing magnification of a subject image formed by the optical system. Each of the focus lens and the like includes one lens or a plurality of lenses.

The lens driver 112 drives the focus lens and the like in the optical system 110. The lens driver 112 includes a motor, and moves a focus lens along an optical axis of the optical system 110 based on control of the controller 135. A configuration for driving a focus lens in the lens driver 112 can be realized by a DC motor, a stepping motor, a servo motor, an ultrasonic motor, or the like.

The image sensor 115 captures a subject image formed via the optical system 110 to generate imaging data. The imaging data constitutes image data indicating an image captured by the image sensor 115. The image sensor 115 generates image data of a new frame at a predetermined frame rate (e.g., 30 frames/second). A generation timing of imaging data and electronic shutter operation in the image sensor 115 are controlled by the controller 135. As the image sensor 115, various image sensors such as a CMOS image sensor, a CCD image sensor, or an NMOS image sensor can be used.

The image sensor 115 executes capturing operation of a still image, capturing operation of a through image, and the like. The through image is mainly a moving image, and is displayed on the display monitor 130 in order for the user to determine a composition for capturing a still image. Each of the through image and the still image is an example of a captured image in the present embodiment. The image sensor 115 is an example of an image sensor of the present embodiment.

The image processing engine 120 performs various processing on imaging data output from the image sensor 115 to generate image data, and performs various processing on image data to generate an image to be displayed on the display monitor 130. Examples of the various processing include white balance correction, gamma correction, YC conversion processing, electronic zoom processing, compression processing, and decompression processing, but the processing is not limited to these examples. The image processing engine 120 may be configured by a hard-wired electronic circuit, or may be configured by a microcomputer using a program, a processor, or the like.

In the present embodiment, the image processing engine 120 includes an image recognizer 122 that realizes a function of detecting a region where a specific subject such as a person is located by image recognition of a captured image. For example, the image recognizer 122 includes a trained model constructed to perform image recognition such as segmentation by machine learning such as a neural network. The image processing engine 120 may be configured integrally with the controller 135, or the image processing engine 120 may be omitted from the digital camera 100.

The display monitor 130 is an example of a display that displays various information. For example, the display monitor 130 displays an image (through image) indicated by image data captured by the image sensor 115 and subjected to image processing by the image processing engine 120. The display monitor 130 displays a menu screen or the like for the user to perform various settings for the digital camera 100. The display monitor 130 can be configured by a liquid crystal display device or an organic EL device, for example.

The user interface 150 is a general term for user interfaces such as hard keys such as an operation button and an operation lever provided on the exterior of the digital camera 100, and software keys, and receives operation by the user. For example, the user interface 150 includes a release button, a mode dial, and a touch panel. When the user interface 150 receives operation by the user, the user interface 150 transmits an operation signal corresponding to the user operation to the controller 135. The user interface 150 is an example of a setting interface of the digital camera 100 in the present embodiment.

The controller 135 integrally controls the entire operation of the digital camera 100. The controller 135 includes a CPU and the like, and the CPU executes a program (software) to realize a predetermined function. The controller 135 may include, instead of the CPU, a processor including a dedicated electronic circuit designed to realize a predetermined function. That is, the controller 135 can be realized by various processors such as a CPU, an MPU, a GPU, a DSP, an FPGA, and an ASIC. The controller 135 may include one or a plurality of processors. The controller 135 may include one semiconductor chip together with the image processing engine 120 and the like.

The buffer memory 125 is a recording medium that functions as a work memory of the image processing engine 120 and the controller 135. The buffer memory 125 is realized by a dynamic random access memory (DRAM) or the like. The flash memory 145 is a nonvolatile recording medium. Further, although not illustrated, the controller 135 may include various internal memories, and may incorporate a ROM, for example. The ROM stores various programs to be executed by the controller 135. Further, the controller 135 may incorporate a RAM that functions as a work area of a CPU.

The card slot 140 is a means into which a removable memory card 142 is inserted. The memory card 142 can be connected to the card slot 140 electrically and mechanically. The memory card 142 is an external memory including a recording element such as a flash memory in the inside. The memory card 142 can store data such as image data generated by the image processing engine 120.

The communication module 155 is a module (circuit) that connects to an external device according to a predetermined communication standard in wired or wireless communication. For example, the predetermined communication standard includes USB, HDMI (registered trademark), IEEE 802.11, Wi-Fi, Bluetooth, and the like. The digital camera 100 can communicate with other devices via the communication module 155.

The microphone 160 includes a plurality of microphone elements incorporated in the digital camera 100, for example. For example, the microphone 160 outputs, to the controller 135, a voice signal indicating voice collected in a plurality of channels so that an arrival direction of the collected voice can be estimated. The microphone 160 that is externally attached may be used for the digital camera 100. The digital camera 100 may include a connector such as a terminal connected to the microphone 160 that is externally attached alternatively or additionally to the microphone 160 that is incorporated.

### 1-2. Configuration of Image Processing Server

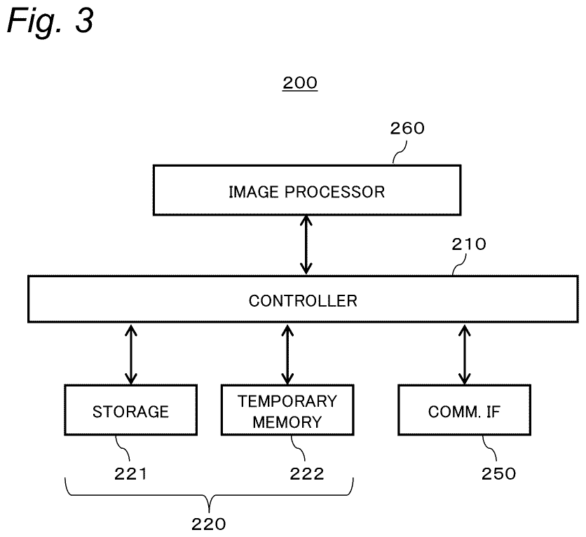

A configuration of the image processing server 200 in the present embodiment will be described with reference to FIG. 3.

FIG. 3 is a diagram exemplifying a configuration of the image processing server 200. The image processing server 200 exemplified in FIG. 3 includes a controller 210, a memory 220, a communication interface 250, and an image processor 260.

The controller 210 includes a CPU or an MPU that realizes a predetermined function in cooperation with software, for example. The controller 210 controls overall operation of the image processing server 200, for example. The controller 210 reads data and a program stored in the memory 220 and performs various arithmetic processing to realize various functions.

For example, the controller 210 executes a program including a command group for realizing each of the above-described functions. The above program may be provided from the communication network 15, or may be stored in a portable recording medium. The controller 210 may be a hardware circuit such as a dedicated electronic circuit or a reconfigurable electronic circuit designed to realize each of the above-described functions. The controller 210 may include various semiconductor integrated circuits such as a CPU, an MPU, a GPU, a GPGPU, a TPU, a microcomputer, a DSP, an FPGA, and an ASIC.

The memory 220 is a storage medium that stores a program and data necessary for implementing a function of the image processing server 200. As illustrated in FIG. 3, the memory 220 includes a storage 221 and a temporary memory 222.

The storage 221 stores a parameter, data, a control program, and the like for realizing a predetermined function. The storage 221 includes an HDD or an SSD, for example. For example, the storage 221 stores the above-described program, various image data, and the like.

For example, the temporary memory 222 includes a RAM such as a DRAM or an SRAM, and temporarily stores (i.e., holds) data. For example, the temporary memory 222 holds image data being edited. Further, the temporary memory 222 may function as a work area of the controller 210, and may be configured by a storage area in an internal memory of the controller 210.

The communication interface 250 is a module (circuit) that connects to an external device according to a predetermined communication standard in wired or wireless communication. For example, the predetermined communication standard includes USB, HDMI, IEEE 802.11, Wi-Fi, Bluetooth, and the like. The communication interface 250 may connect the image processing server 200 to a communication network such as the Internet. The communication interface 250 is an example of an input interface that receives various pieces of information from an external device or a communication network.

The image processor 260 performs various image processing on image data received from the communication interface 250 to generate processed image data, for example. The image processor 260 may be configured by a hard-wired electronic circuit, or may be configured by a microcomputer using a program, a processor, or the like.

The configuration of the image processing server 200 as described above is an example, and the configuration of the image processing server 200 is not limited to this. For example, the controller 210 and the image processor 260 may be integrally configured. The input interface in the image processing server 200 may be realized by cooperation with various software in the controller 210 and the like. An input interface in the image processing server 200 may acquire various information by reading various information stored in various storage media (e.g., the storage 221) to a work area (e.g., the temporary memory 222) of the controller 210.

### 2. Operation

The operation of the present system 10 configured as described above will be described below.

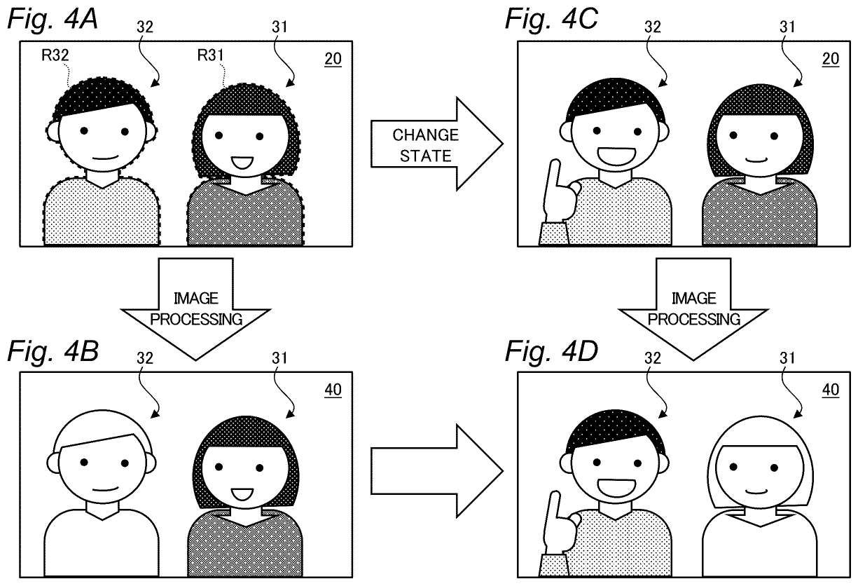

The present system 10 performs image processing such as color leaving processing of leaving a color only in a specific subject on the basis of a recognition result of the subject in the digital camera 100, for example. An outline of operation of the present system 10 will be described with reference to FIGS. 4A to 4D.

FIGS. 4A to 4D are diagrams for explaining operation of the imaging system 10 of the first embodiment. The present system 10 determines a subject on which to leave a color according to a state of the subject, so as to color a person in a predetermined state, such as uttering, singing, laughing, or making a gesture at the time of shooting of a video such as a movie, a drama, a talk show, or a live video.

FIG. 4A illustrates an example of a captured image 20 in the digital camera 100. FIG. 4B exemplifies a processed image 40 as a result of image processing performed on the captured image 20 of FIG. 4A in the present system 10. FIG. 4C exemplifies the captured image 20 in which a state of a subject changes from FIG. 4A. FIG. 4D exemplifies the processed image 40 of the processing result of the captured image 20 of FIG. 4C.

FIGS. 4A and 4C exemplifies the captured images 20 of different frames in a shooting scene in which two persons 31 and 32 as subjects have a conversation in a video (hereinafter also referred to as an “original video”) shot by the digital camera 100. The digital camera 100 according to the present embodiment sequentially detects person regions R31 and R32 along outer shapes of the persons 31 and 32 during shooting of an original video, for example. The person regions R31 and R32 are examples of subject regions used for various shooting control in the digital camera 100, e.g., automatic focusing operation (AF) or automatic exposure determination (AE).

Using a detection result of the person regions R31 and R32, the present system 10 performs image processing on the captured image 20 so as to highlight a subject in a predetermined state such as the person 31 who is speaking as illustrated in FIGS. 4A and 4B, and generates the processed image 40. For example, the image processing of the present system 10 is color leaving processing for making the outside of the person region R31 achromatic while leaving a color inside the person region R31 corresponding to the person 31 who is speaking.

For example, the present system 10 detects a subject in the above-described predetermined state for each frame of the original video (FIGS. 4A and 4C), and generates a video (FIGS. 4B and 4D) including the processed image 40 in which a subject to be highlighted is dynamically determined from the captured image 20. For example, from the captured image 20 of a frame in which a speaker is changed as illustrated in FIG. 4C from a state of FIG. 4A, as illustrated in FIG. 4D, the processed image 40 in which the person 32 who is newly speaking is highlighted is obtained instead of the person 31 who stops speaking.

As described above, according to the present system 10, a subject to which a highlighting video effect is to be applied is determined according to a state of a dynamically changing subject such as utterance of the persons 31 and 32. By this, the present system 10 can easily add video expression desired by the user to a video shot by the user. Hereinafter, an example in which such operation of the present system 10 is applied to a workflow of video creation will be described.

### 2-1. Overall Operation

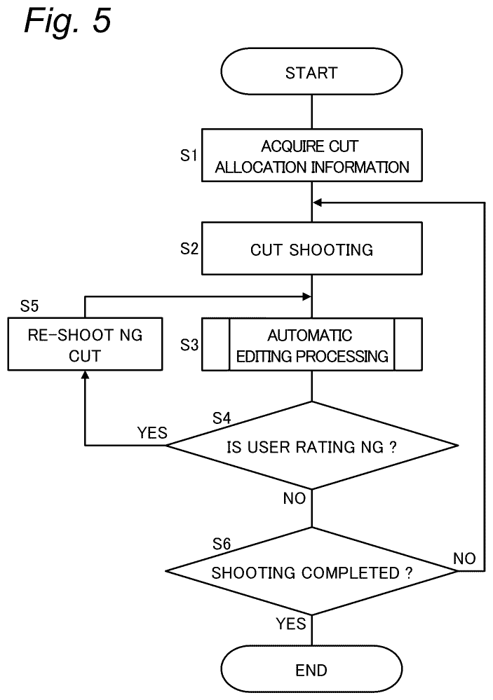

Entire operation of the digital camera 100 in the present system 10 will be described with reference to FIGS. 5 to 7.

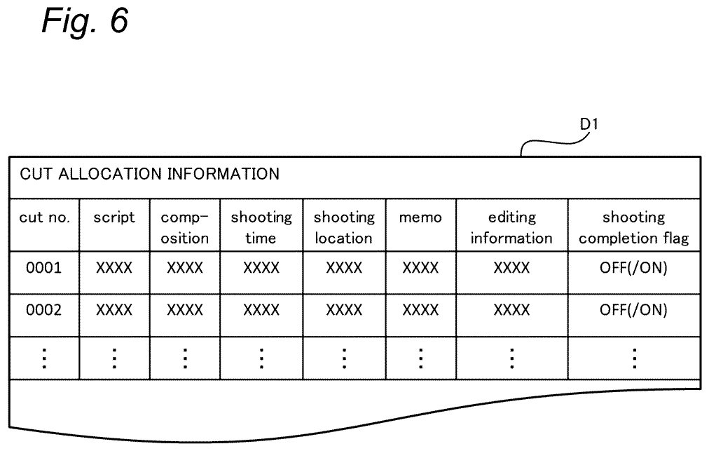

FIG. 5 is a flowchart exemplifying operation of the digital camera 100 in the present system 10. In the present embodiment, an operation example of performing image processing as exemplified in FIGS. 4A to 4D in the digital camera 100 will be described. FIG. 6 exemplifies a data structure of cut allocation information D1 in the present system 10.

First, the controller 135 of the digital camera 100 acquires the cut allocation information D1 for managing a scenario desired by the user for each cut in the present system 10 according to operation of the user, for example (S1). FIG. 6 illustrates the cut allocation information D1 in the present system 10.

For example, as illustrated in FIG. 6, the cut allocation information D1 manages “script”, “composition”, “shooting time”, “shooting location”, “editing information”, and “shooting completion flag” in association with each other for each “cut number”. The cut allocation information D1 is an example of management information in the present embodiment. The cut allocation information D1 is stored in the flash memory 145 of the digital camera 100, for example.

The “cut number” indicates identification information of a cut corresponding to various shooting scenes in a scenario desired by the user. The “script” stores text information such as a script divided for the cut in the scenario. The “composition” stores image information indicating a composition or the like in video shooting of the cut. The input of the image information may be drawing by user operation or designation of image data.

The “shooting time” stores numerical information indicating rough time length for shooting a video of the cut. The “shooting location” stores position information indicating a location where a video of the cut is shot. The “note” stores various information desired by the user, such as imaging equipment, regarding a video shooting of the cut.

The “editing information” includes various information indicating a schedule for performing editing by image processing on a video of the cut, and includes, e.g., identification information of a subject as a target to which color leaving processing or the like is applied. The “editing information” may include a state (e.g., “speaking”) of a subject to be edited, a type (e.g., “color leaving processing”) of image processing, and the like.

The “shooting completion flag” manages whether the cut is in a state of shooting completion or in a state of shooting incompletion by ON/OFF. For example, in an initial state of the cut allocation information D1, the shooting completion flag is set to OFF for all cuts.

In the present system 10, the cut allocation information D1 as described above may be created in accordance with user operation in the image editing PC 300 or may be managed in the image processing server 200, for example.

In Step S1 of FIG. 5, the cut allocation information D1 may be input to the digital camera 100 by data communication with the image editing terminal 300 or the image processing server 200. Alternatively, the user may input the cut allocation information D1 to the digital camera 100 via a portable recording medium such as the memory card 142. In the digital camera 100, a user interface for supporting creation of the cut allocation information D1 may be provided.

Next, referring to the acquired cut allocation information D1 the controller 135 of the digital camera 100 manages video shooting for each cut by the user, for example (S2). For example, in Step S2, the controller 135 causes the display monitor 130 to display a selection screen for a plurality of cuts included in the cut allocation information D1, receives user operation for selecting a cut from the selection screen on the user interface 150, and records shooting of a video in association with the selected cut.

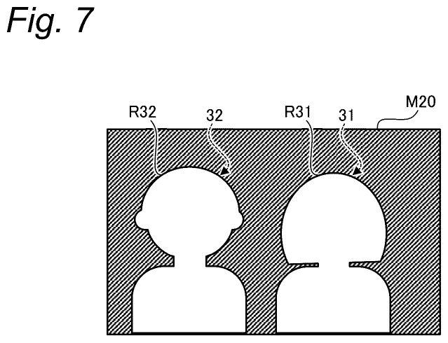

In Step S2, an original video including the captured image 20 exemplified in FIGS. 4A and 4C is shot, for example. For example, the digital camera 100 detects a subject region during such video shooting (S2). Detection operation of a subject region in the present system 10 will be described with reference to FIG. 7.

FIG. 7 illustrates a region divided map M20 of a detection result for the captured image 20 of FIG. 4A. For example, the image recognizer 122 of the digital camera 100 inputs the captured image 20 for each frame from the image sensor 115 to a trained model for image recognition such as a segmentation technique, and sequentially generates the region divided map M20 from output of the trained model (S2).

The above-described trained model is constructed by machine learning so as to calculate a probability value of whether a subject of a specific type such as a person is shown for each pixel in an input image, for example. For example, in Step S2, the image recognizer 122 performs threshold determination on a probability value for each pixel in output of the trained model, and generates the region divided map M20. According to the region divided map M20, it is possible to detect the person regions R31 and R32 having a shape along an outer shape of the persons 31 and 32 as illustrated in FIG. 7 corresponding to the persons 31 and 32 shown in the captured image 20 of FIG. 4A, for example.

For example, by using the region divided map M20, the digital camera 100 according to the present embodiment can use any of the person regions R31 and R32 as a region for calculating an rating value of AF operation, or for other various shooting control (e.g., AE control) (S2). The controller 135 of the digital camera 100 stores a detection result such as the region divided map M20 for each frame in the buffer memory 125 in Step S2, for example. Alternatively, the controller 135 may record information of a detection result in metadata of a video file. At the time of the video shooting for each cut as described above, the controller 135 of the digital camera 100 collects sound with the microphone 160, and includes sound data together with image data in a video file to be recorded, for example.

Next, the controller 135 performs image processing of automatic editing on a video shot in Step S2, based on editing information in the cut allocation information D1, for example (S3). In the automatic editing processing (S3) of the present embodiment, for example, a predetermined state of a subject designated in the editing information is detected from the original video illustrated in FIGS. 4A and 4C, and image processing using the person regions R31 and R32 is performed as exemplified in FIGS. 4B and 4D. Details of the processing of Step S3 will be described later.

Next, the controller 135 of the digital camera 100 determines whether or not user's rating of a video of a cut shot in Step S2 is “No Good (NG)”, for example (S4). For example, “NG” indicates rating in which the user determines not to adopt the video in video work.

For example, in Step S4, the controller 135 causes the display monitor 130 to reproduce and display a video as a result of the automatic editing processing (S3), and receives, in the user interface 150, user operation of selecting rating of shooting of the video (S4). For example, the digital camera 100 presents the user with two choices of “OK” and “NG” as options of rating of video shooting. For example, “OK” indicates rating in which the user determines that the video can be adopted as video work. Such rating options are not particularly limited to the above two options, and for example, an option “KEEP” between “OK” and “NG” may be further presented.

For example, when user's rating is NG (YES in S4), the controller 135 performs processing of shooting and recording a video associated with a cut of NG again (S5), and performs the automatic editing processing (S3) on the video shot again. Instead of the processing of Step S5, the controller 135 may perform notification to prompt the user to perform shooting for the cut of NG again and proceed to Step S6. In this case, whether or not to perform cut shooting after the above may be determined according to user's decision.

On the other hand, when the user's rating is not NG (NO in S4), referring to the shooting completion flag of the cut allocation information D1, the controller 135 determines whether or not video shooting of all the cuts is completed, for example (S6). For example, when the processing proceeds to NO in Step S4, the controller 135 updates the shooting completion flag of a corresponding cut to ON, and performs the determination in Step S6. When the video shooting is not completed for all the cuts (NO in S6), the processing in and after Step S2 is repeated for a cut for which shooting is not completed.

When video shooting of all cuts is completed (YES in S6), the controller 135 ends the processing of the flowchart illustrated in FIG. 5. After the above, the present system 10 performs, in the image editing terminal 300 or the image processing server 200, editing for completing video work using a processed video for each cut appropriately, for example.

According to the above processing, in the present system 10, the digital camera 100 can perform information support for improving workflow of video creation according to a scenario by the automatic editing processing (S3) using a detection result of a subject region. For example, when the user evaluates a video shot for each cut, the digital camera 100 of the present embodiment reproduces and displays a processed video (FIGS. 4B and 4D) for which the automatic editing processing (S3) is performed, so that the user can easily perform rating in consideration of a completed form of video work.

### 2-2. Automatic Editing Processing

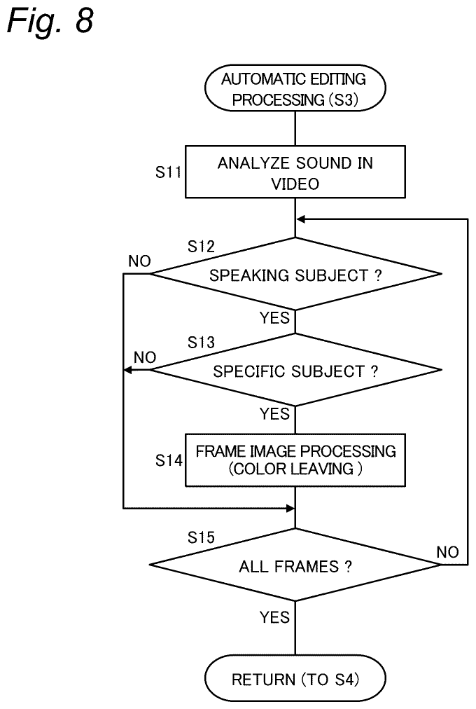

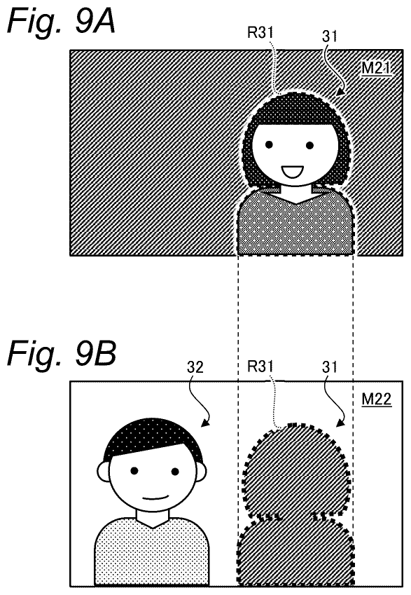

Details of the automatic editing processing in Step S3 of FIG. 5 will be described with reference to FIGS. 8 and 9.

FIG. 8 is a flowchart exemplifying the automatic editing processing in the present system 10. The processing illustrated in the flow of FIG. 8 is started in a state where a video of one cut is newly shot and recorded in Step S2, for example.

First, the controller 135 analyzes sound data in a video file for one cut to be automatically edited, for example (S11). For example, the controller 135 detects a time section in which a speech sound is included in sound data in a video, or performs estimation (DOA estimation) of a direction in which a speech sound arrives. The controller 135 may perform individual identification of a speaker by characteristic analysis of a speech sound.

Next, the controller 135 detects the presence or absence of a speaking subject for each frame of a video file, for example (S12). The detection processing in Step S12 is performed, based on image data of a video file and the analysis result (S11) of sound data, for example.

For example, in Step S12, a predetermined state of a subject is detected by image analysis or the like for analyzing movement of a part such as the mouth of a person as a subject. For example, the person 31 who is speaking may be detected by analyzing a feature related to speaking such as whether or not the mouth of the persons 31 and 32 is open from the captured image 20 of FIG. 4A. From a result of the voice analysis (S11), a position where the presence of a speaker is estimated on the captured image 20 may be calculated by DOA estimation of a speech sound.

When a subject that is speaking is detected (YES in S 12), the controller 135 determines whether or not the detected subject that is speaking corresponds to a specific subject based on the editing information in the cut allocation information D1, for example (S13). The specific subject is set in the editing information as an object to be highlighted by image processing, for example.

According to the processing in Step S13, even when audience or the like that is not assumed as a performer in a scenario is in a state of speaking, it is possible not to perform highlighting of an unexpected subject in particular, for example. The determination in Step S13 may be made by image recognition of individual identification. Alternatively, the processing may be performed by comparison between a position of a performer in a composition of the cut allocation and a position of a person detected on the captured image 20. For example, in the case where a plurality of subjects are detected to be in a state of speaking in Step S12 (YES in S12), when any of a plurality of subjects corresponds to a specific subject, the processing proceeds to YES in Step S13. The processing in Step S13 may be omitted as appropriate.

When determining that the detected subject that is speaking corresponds to a specific subject (YES in S13), the controller 135 controls the image processing engine 120 to perform image processing such as color leaving processing on the captured image 20 of a current frame according to the person region R31 of the subject, and generates the processed image 40 (S14). The image processing in Step S14 will be described with reference to FIGS. 9A and 9B.

FIG. 9A illustrates a mask image M21 obtained by extracting the inside of the person region R31 detected from the captured image 20 of FIG. 4A. FIG. 9B illustrates a mask image M22 obtained by extracting the outside of the person region R31 detected in the captured image 20 of FIG. 4A.

In Step S14, first, referring to the region divided map M20 (FIG. 7), the controller 135 controls the image processing engine 120 to generate, as intermediate data, the mask images M21 and M22 obtained by extracting the inside and the outside of the detected person region R31, respectively from the captured image 20 as illustrated in FIGS. 9A and 9B, for example.

For example, in the color leaving processing (S14), the controller 135 performs monochrome image processing of changing the mask image M22 (FIG. 9B) obtained by extracting the outside of the person region R31 to achromatic. Next, the controller 135 controls the image processing engine 120 to generate the processed image 40 by combining the mask image M21 (FIG. 9A) in which the inside of the person region R31 is left with the mask image M22 (FIG. 9B) in which the outside is changed to monochrome.

On the other hand, when it is determined that the detected subject that is speaking does not correspond to a specific subject (NO in S13) or when a subject that is speaking is not detected (NO in S12), the controller 135 proceeds to Step S15 without particularly performing the processing of Step S14, for example.

For example, the controller 135 determines whether or not the detection processing (S12) of a subject in a predetermined state is performed on all frames in a video file to be processed (S15). When the detection processing in Step S13 is not performed on all frames (NO in Step S15), the controller 135 repeats the processing in and after Step S12 for a frame that is not processed in Step S12 in the video file.

When the detection processing in Step S13 is performed on all frames (YES in S15), the controller 135 ends the automatic editing processing (S3) and proceeds to the processing in Step S4 in FIG. 5, for example.

According to the above automatic editing processing (S3 in FIG. 8), when a subject in a predetermined state such as the person 31 who is speaking is detected (YES in S13), image processing is performed so as to apply different image effects to the inside and the outside of the person region R31 (S14). By this, in an exemplary scene where the person 31 who is speaking in a video is present, presentation of a highlighting effect is performed in such a manner that a portion other than the person 31 is changed to monochrome (see FIG. 4B), and a presentation effect that attracts attention of an observer can be easily obtained.

The image processing in Step S14 is not particularly limited to the above example. For example, in the image processing engine 120, instead of the mask image M22 leaving the outside of the person region R31, an image obtained by changing the entire captured image 20 to monochrome may be used, and the mask image M21 may be superimposed on such a monochrome image. In such superimposition and synthesis, the mask image M21 is in a layer above a monochrome image, and transparent attribute is adopted for a region other than a portion of the corresponding person region R31 in the mask image M21.

In Step S14, image processing of imparting various image effects may be performed on the mask image M21 (FIG. 9A) leaving the inside of the person region R31, for example. For example, different color corrections may be performed inside and outside the person regions R31 and R32, in such a manner as increasing saturation of the mask image M21 leaving the inside of the person region R31 and decreasing saturation of the other mask image M22.

In Step S14, the captured image 20 of one frame may be input to two image correction circuits, and image processing for the inside and the outside of a subject region may be performed in parallel in each of the image correction circuits, for example. The processed image 40 may be generated by combining the images obtained as described above with each other.

The above description explains the operation example in which the region divided map M20 obtained at the time of shooting of a video in the digital camera 100 is left and used for the processing of Step S14. The digital camera 100 of the present embodiment does not need to leave the region divided map M20 at the time of shooting of a video, and for example, the controller 135 may cause the image recognizer 122 to perform detection operation of a subject region again at the time of the processing of Step S14. This also makes it possible to efficiently realize image processing along a subject region using the image recognizer 122 of the digital camera 100.

### 3. Review

As described above, in the present embodiment, the digital camera 100 as an example of the imaging apparatus includes the image sensor 115 as an example of an image sensor, the image processing engine 120 as an example of an image processor, and the controller 135. The image sensor 115 captures a subject image and generates the captured image 20. The image processing engine 120 performs image processing on the captured image 20 generated by the image sensor 115. The controller 135 controls image processing by the image processing engine 120 based on the captured image 20. The controller 135 detects a subject in a predetermined state from the captured image 20 (S12). When a subject in a predetermined state is detected (YES in S12), the controller 135 causes the image processing engine 120 to perform image processing so as to generate the processed image 40 to which different image effects are imparted between the inside and the outside of a subject region corresponding to the subject in a predetermined state in the captured image 20 (S14).

According to the digital camera 100 described above, it is possible to facilitate to realize a desired image effect on a captured subject by image processing of imparting different image effects to the inside and the outside of a subject region corresponding to a subject in a predetermined state.

In the digital camera 100 of the present embodiment, the controller 135 detects a subject in a predetermined state by analyzing movement of a part of the subject in the captured image 20 based on a plurality of the captured images 20 acquired from the image sensor 115 (S12). By this, it is possible to detect a predetermined state in which a part of a subject moves and to apply a desired image effect along its subject region.

In the digital camera 100 of the present embodiment, the image effect is an effect in which color tones are separately adjusted between the inside and the outside of a subject region. According to the present system 10, a desired color tone effect can be easily realized for a captured subject.

In the digital camera 100 of the present embodiment, the person regions R31 and R32 as an example of a subject region are regions along outer shapes of the persons 31 and 32 as an example of a subject in the captured image 20. When a subject in a predetermined state is detected, the image processing engine 120 generates the processed image 40 in a manner varying an image effect along an outer shape of the subject in a predetermined state in the captured image 20. By this, image effects can be made different between regions along an outer shape of a subject in the captured image 20, and a desired image effect on a captured subject can be easily realized.

In the present embodiment, the digital camera 100 further includes the image recognizer 122 that recognizes a subject region corresponding to a subject in the captured image 20 based on the captured image 20 generated by the image sensor 115. The controller 135 controls image shooting operation by the image sensor 115 based on a subject region recognized by the image recognizer 122. By this, a desired image effect on a captured subject can be easily realized using the image recognizer 122 of the digital camera 100.

In the digital camera 100 of the present embodiment, when a subject in a predetermined state is not detected (NO in S12), the controller 135 controls image processing by the image processing engine 120 so as not to impart different image effects between the inside and the outside of a subject region corresponding to a subject that is not in a predetermined state in the captured image 20. For example, the digital camera 100 according to the present embodiment can generate a video including both the processed image 40 in which a subject in a predetermined state is detected and the captured image 20 in which a subject in a predetermined state is not detected.

In the present embodiment, the digital camera 100 further includes the flash memory 145 as an example of a memory that stores the cut allocation information D1 as an example of management information for managing a schedule in which image shooting is performed in one or a plurality of shooting scenes. The controller 135 manages a subject in a predetermined state for each shooting scene with reference to editing information of the cut allocation information D1, for example. By this, the user can easily realize an image effect desired by the user by including a predetermined state of a desired subject in the cut allocation information D1.

The imaging method according to the present embodiment is an imaging method including a step (S2) of the image sensor 115 capturing a subject image and generating the captured image 20, a step (S3) of the image processing engine 120 performing image processing on the captured image 20 generated by the image sensor 115, and steps (S12 to S14) of the controller 135 controlling image processing by the image processing engine 120 based on the captured image 20. In the present method, the controller 135 detects a subject in a predetermined state from the captured image 20 (S12), and when a subject in a predetermined state is detected (YES in S12), the image processing engine 120 is caused to perform image processing so as to generate the processed image 40 to which different image effects are imparted between the inside and the outside of a subject region corresponding to the subject in a predetermined state in the captured image 20 (S14). According to the present method, it is possible to easily realize a desired image effect on a captured subject.

A program including instructions for causing a processor such as the controller 135 to perform the present method may be provided. Such a program may include a step of the processor acquiring the captured image 20 in which the subject image is captured.

### Second Embodiment

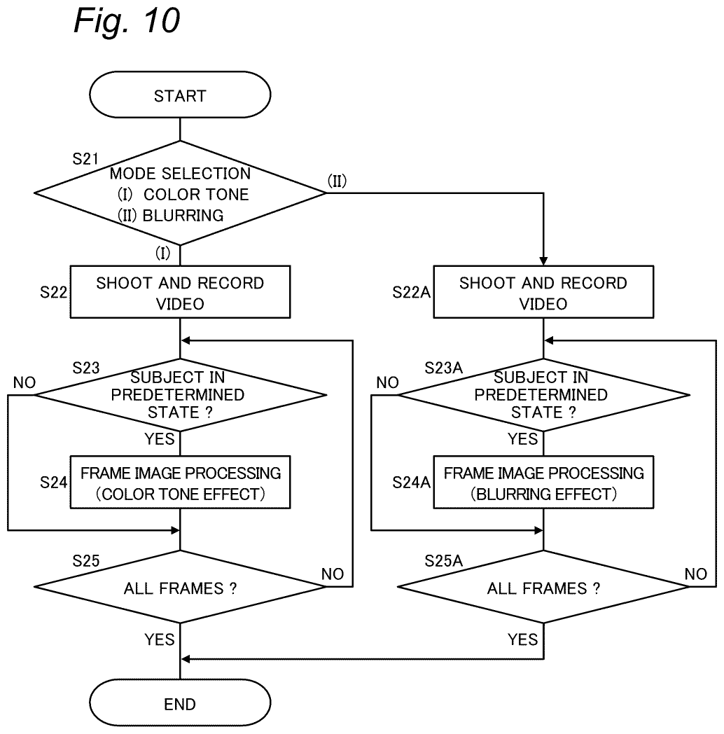

Hereinafter, a second embodiment of the present disclosure will be described with reference to FIG. 10. In the first embodiment, the imaging system 10 that imparts an image effect for presentation in a scenario of video creation is described, but the present disclosure is not limited to this. In the second embodiment, the imaging system 10 according to such a variation will be described.

Hereinafter, description of a configuration and operation similar to those of the imaging system 10 and the digital camera 100 according to the first embodiment will be omitted as appropriate, and the imaging system 10 and the digital camera 100 according to the present embodiment will be described.

FIG. 10 is a flowchart exemplifying operation of the digital camera 100 in the imaging system 10 of the second embodiment. In the first embodiment, image processing is performed on a subject in a predetermined state with reference to the cut allocation information D1 for managing a scenario. In the imaging system 10 according to the present embodiment, the digital camera 100 provides a plurality of operation modes dedicated for image processing on a subject in a predetermined state, for example.

For example, in the digital camera 100 according to the present embodiment, the controller 135 selects an operation mode to be applied from a plurality of dedicated operation modes in accordance with user operation on the user interface 150 (S22). In the example of FIG. 10, the dedicated operation modes include (I) an operation mode of a color tone effect and (II) an operation mode of a blurring effect. For example, the controller 135 causes the display monitor 130 to display a selection screen for presenting the options (I) and (II) of operation modes, and receives user operation of selecting any of the options on the user interface 150 (S22).

In the case where the operation mode of a color tone effect is selected ((I) in S 21), for example, when a subject in a predetermined state is detected for each frame after shooting and recording of a video (S22) (YES in S23), the controller 135 sequentially performs image processing for making color tone effects different between the inside and the outside of a corresponding subject region (S24 and S25). The image processing of a color tone effect can be performed similarly to the automatic editing processing (FIG. 8) of the first embodiment, for example. Various color correction such as color grading or tone mapping may be adopted as a color tone effect.

In the case where the operation mode of a blurring effect is selected ((II) in S21), the controller 135 performs image processing of a blurring effect (S24A) instead of Step S24, for example, when performing Steps S22A to S25A similar to the processing of the operation mode of a color tone effect (S22 to S25). For example, the image processing in Step S24A is performed by imparting a blurring effect so as to selectively blur the outside of a subject region corresponding to a subject in a predetermined state. By this, a blurred image can be realized except for a subject in a predetermined state, and it is possible to obtain highlighting performance that attracts attention to a person or the like who is speaking, for example.

For example, such image processing can be performed by using the mask images M21 and M22 inside and outside a subject region similarly to the example of FIG. 9. The blurring effect may be imparted as an image effect similar to motion blur caused by movement of a subject other than a highlighting target. For example, an image effect of producing motion blur before and after a frame in which a subject in a predetermined state is detected may be imparted.

An image effect imparted in the present system 10 is not limited to the above, and may be a visual effect such as various video effects created by editing or processing a video or a video. For example, time effects such as slow motion and time lapse, or transition effects such as whiteout and fade-in and fade-out may be adopted in the present system 10. Further, special effects for creating a scene or an image that cannot be realized in reality, e.g., explosion, collapse, flight, appearance of a ghost or a monster, and the like may be included. Special effects for creating a realistic video or a fantasy world by using CGs may be applied to the present system 10.

By using image effect application of the present system 10, it is possible to enhance attraction and information transmission of a video and express atmosphere and feeling of a story. In the present system 10, the dedicated operation mode is not limited to an image effect, and a subject in a predetermined state to be a detection target may be defined.

As described above, in the imaging system 10 according to the present embodiment, the digital camera 100 further includes the user interface 150 as an example of an input interface that receives user operation for selecting any of a plurality of operation modes corresponding to a plurality of image effects. In accordance with user operation on the input interface, the controller 135 causes the image processing engine 120 to perform image processing so as to impart an image effect corresponding to an operation mode selected by user operation (S21, S24, and S24A). By this, the user can easily realize an image effect desired by the user by selecting a desired operation mode.

### Other Embodiments

As described above, the first to second embodiments are described as an example of the technique disclosed in the present application. However, the technique in the present disclosure is not limited to this, and is applicable to embodiments in which changes, replacements, additions, omissions, and the like are appropriately made. Further, the constituent elements described in the above-described first to second embodiments can also be combined to form a new embodiment.

In the first embodiment described above, an operation example of the imaging system 10 when the person 31 who is speaking is a subject in a predetermined state as a detection target is described, but the present disclosure is not particularly limited to this.

In the present embodiment, the predetermined state to be a detection target of the imaging system 10 may be a state in which a person as a subject makes a gesture such as raising a finger or a state of a specific expression such as smiling, for example. In the present system 10, the controller 135 may detect the above-described predetermined state by analyzing a change in a part such as a face or a finger of a subject in a captured image, for example.

The present system 10 may detect a person performing suspicious behavior (i.e., a suspicious person) as a subject in a predetermined state. The present system 10 may be applied to a crime prevention application or the like using the digital camera 100 for a monitoring camera that shoots a space to be monitored such as a public place or a store, for example. In the present embodiment, for example, the controller 135 may calculate a motion vector of each person extracted from a captured image of the digital camera 100, and may detect a person with a motion vector in which degree of deviation from a tendency of a group obtained by statistics of motion vectors of a plurality of persons in the past is larger than a predetermined threshold as a suspicious person. In the present system 10, a person with various behaviors such as predetermined behaviors such as coming to see the same product many times or staying at the same place for a long time may be detected as a subject in a predetermined state.

As described above, in the digital camera 100 according to the present embodiment, the predetermined state may be at least one of speaking, a gesture, a smile, and a specific behavior of a person as a subject. According to the present system 10, a desired image effect can be applied along a subject region according to such a state of a person.

In the first embodiment, an operation example of performing image processing such as the automatic editing processing (S3 in FIG. 5) in the digital camera 100 is described. The present system 10 is not particularly limited to this, and for example, some processing may be performed by the image processing server 200. For example, the image processing server 200 of the present embodiment may receive data of an original video from the digital camera 100 via the communication network 15 or the like. The controller 210 may cause the image processor 260 to perform the automatic editing processing (FIG. 5, S3) on the captured image 20 included in original video data. The controller 210 of the image processing server 200 may acquire information of a detection result (FIG. 7) of a subject region together with data of the captured image 20, or the controller 210 of the image processing server 200 may perform detection operation of a subject region similarly to the controller 135.

As described above, the imaging system 10 according to the present embodiment includes the digital camera 100 and the image processing server 200 as an example of an image processing apparatus. The digital camera 100 includes the image sensor 115 that captures a subject image and generates the captured image 20, and the communication module 155 as an example of a transmitter that transmits image data indicating the captured image 20 to an image processing apparatus. The image processing server 200 includes the communication interface 250 as an example of a receiver that receives image data from the digital camera 100, and the image processor 260 that performs image processing on the captured image 20 indicated by image data based on image data received by the receiver. The digital camera 100 or the image processing server 200 includes the controller 135 or 210 that causes the image processor 260 to perform image processing so as to generate the processed image 40 to which different image effects are imparted between the inside and the outside of a subject region corresponding to a subject in a predetermined state in the captured image 20 when the subject in a predetermined state is detected from the captured image 20. According to the present system 10, it is possible to easily realize a desired image effect on a captured subject.

In the above embodiments, the example in which a subject as a target of image processing in the imaging system 10 is one person, but the present disclosure is not limited to this. In the imaging system 10 of the present embodiment, a subject as a target of image processing may be a plurality of persons, or may be a moving object such as an animal or a vehicle without limitation to a person.

In the above embodiments, a video in the imaging system 10 is exemplified as a target of image processing. In the imaging system 10 of the present embodiment, a target of image processing is not particularly limited to a video, and may be a still image.

In the above embodiments, the digital camera 100 including the optical system 110 and the lens driver 112 is exemplified. The imaging apparatus of the present embodiment may not include the optical system 110 and the lens driver 112, and may be an interchangeable lens type camera, for example.

In the above embodiments, the digital camera is described as an example of an imaging apparatus, but the present invention is not limited to this. The imaging apparatus of the present disclosure only needs to be an electronic device (e.g., a video camera, a smartphone, a tablet terminal, or the like) having an image shooting function.

### Aspect Example

Hereinafter, various aspects according to the present disclosure will be listed.

A first aspect of the present disclosure is an imaging apparatus including: an image sensor that captures a subject image to generate a captured image; an image processor that performs image processing on the captured image generated by the image sensor; and a controller that controls image processing by the image processor, based on the captured image. The controller detects a subject being in a predetermined state, from the captured image, and causes the image processor to perform the image processing generating a processed image when the subject in the predetermined state is detected, the processed image having an image effect different between an inside and an outside of a subject region corresponding to the subject in the predetermined state in the captured image.

A second aspect is the imaging apparatus according to the first aspect, wherein the controller detects the subject in the predetermined state by analyzing movement of a part of the subject in the captured image based on a plurality of captured images acquired from the image sensor.

A third aspect is the imaging apparatus according to the first or second aspect, wherein the predetermined state is at least one of speaking, a gesture, a smile, or a specific behavior of a person as the subject.

A fourth aspect is the imaging apparatus according to any one of the first to third aspects, wherein the image effect is an effect in which a color tone is separately adjusted between the inside and the outside of the subject region.

A fifth aspect is the imaging apparatus according to any one of the first to fourth aspects, wherein the subject region is a region having a shape along an outer shape of the subject in the captured image. When the subject in the predetermined state is detected, the image processor generates the processed image to cause the image effect to be different along the outer shape of the subject in the predetermined state in the captured image.

A sixth aspect is the imaging apparatus according to any one of the first to fifth aspects, further including an image recognizer that recognizes a subject region, based on the captured image generated by the image sensor, the subject region corresponding to the subject in the captured image. The controller controls image shooting operation by the image sensor, based on the subject region recognized by the image recognizer.

A seventh aspect is the imaging apparatus according to any one of the first to sixth aspects, when the subject in the predetermined state is not detected, the controller controls the image processing by the image processor not to cause the image effect different between the inside and the outside of the subject region corresponding to the subject not in the predetermined state in the captured image.

An eighth aspect is the imaging apparatus according to any one of the first to seventh aspects, further including a memory that stores management information for managing a schedule in which image shooting is performed in one or more shooting scenes. The controller manages the subject in the predetermined state for each of the shooting scenes, referring to the management information.

A ninth aspect is the imaging apparatus according to any one of the first to eighth aspects, further including an input interface that receives user operation selecting any operation mode of a plurality of operation modes corresponding to a plurality of image effects. The controller causes the image processor to perform the image processing to cause the image effect corresponding to the selected operation mode by the user operation, according to the user operation in the input interface.

A tenth aspect is an imaging method including: capturing, by an image sensor, a subject image to generate a captured image; performing, by an image processor, image processing on the captured image generated by the image sensor; and controlling, by a controller, the image processing by the image processor, based on the captured image. The controller detects a subject being in a predetermined state, from the captured image, and causes the image processor to perform the image processing to generate a processed image in response to detecting the subject in the predetermined state, the processed image having an image effect different between an inside and an outside of a subject region corresponding to the subject in the predetermined state in the captured image.

An eleventh aspect is an imaging system including an imaging apparatus and an image processing apparatus. The imaging apparatus includes: an image sensor that captures a subject image to generate a captured image; and a transmitter that transmits image data indicating the captured image to the image processing apparatus. The image processing apparatus includes: a receiver that receives the image data from the imaging apparatus; and an image processor that performs, based on the image data received by the receiver, image processing on the captured image indicated by the image data. The imaging apparatus or the image processing apparatus includes: a controller that detects a subject being in a predetermined state, from the captured image, and causes the image processor to perform the image processing to generate a processed image when the subject in the predetermined state is detected, the processed image having an image effect different between an inside and an outside of a subject region corresponding to the subject in the predetermined state in the captured image.

As described above, the embodiment is described as an exemplification of the technique in the present disclosure. For this purpose, the accompanying drawings and the detailed description are provided.

Accordingly, the constituent elements described in the accompanying drawings and the detailed description may include not only a constituent element essential for solving the problem, but also a constituent element not essential for solving the problem in order to exemplify the technique. For this reason, it should not be recognized that those non-essential constituent elements are essential just because those non-essential constituent elements are described in the accompanying drawings and the detailed description.

Further, the above-described embodiment is provided to exemplify the technique in the present disclosure, and hence it is possible to make various changes, replacements, additions, omissions, and the like within the scope of claims or the scope equivalent to claims.

The present disclosure is applicable to various applications in which image processing is performed on an image in which a subject is captured.

1. An imaging apparatus comprising:
an image sensor that captures a subject image to generate a captured image;
an image processor that performs image processing on the captured image generated by the image sensor; and
a controller that controls image processing by the image processor, based on the captured image, wherein
the controller
detects a subject being in a predetermined state, from the captured image, and
causes the image processor to perform the image processing generating a processed image when the subject in the predetermined state is detected, the processed image having an image effect different between an inside and an outside of a subject region corresponding to the subject in the predetermined state in the captured image.

2. The imaging apparatus according to claim 1, wherein the controller detects the subject in the predetermined state by analyzing movement of a part of the subject in the captured image based on a plurality of captured images acquired from the image sensor.

3. The imaging apparatus according to claim 1, wherein the predetermined state is at least one of speaking, a gesture, a smile, or a specific behavior of a person as the subject.

4. The imaging apparatus according to claim 1, wherein the image effect is an effect in which a color tone is separately adjusted between the inside and the outside of the subject region.

5. The imaging apparatus according to claim 1, wherein
the subject region is a region having a shape along an outer shape of the subject in the captured image, and
when the subject in the predetermined state is detected, the image processor generates the processed image to apply the image effect to be different along the outer shape of the subject in the predetermined state in the captured image.

6. The imaging apparatus according to claim 1, further comprising
an image recognizer that recognizes the subject region, based on the captured image generated by the image sensor, the subject region corresponding to the subject in the captured image, wherein
the controller controls image shooting operation by the image sensor, based on the subject region recognized by the image recognizer.

7. The imaging apparatus according to claim 1, further comprising
a memory that stores management information for managing a schedule in which image shooting is performed in one or more shooting scenes, wherein
the controller manages the subject in the predetermined state for each of the shooting scenes, referring to the management information.

8. The imaging apparatus according to claim 1, further comprising
an input interface that receives user operation selecting any operation mode of a plurality of operation modes corresponding to a plurality of image effects, wherein
the controller causes the image processor to perform the image processing to apply the image effect corresponding to the selected operation mode by the user operation, according to the user operation in the input interface.

9. An imaging method comprising:
capturing, by an image sensor, a subject image to generate a captured image;
performing, by an image processor, image processing on the captured image generated by the image sensor; and
controlling, by a controller, the image processing by the image processor, based on the captured image, wherein
the controller
detects a subject being in a predetermined state, from the captured image, and
causes the image processor to perform the image processing to generate a processed image in response to detecting the subject in the predetermined state, the processed image having an image effect different between an inside and an outside of a subject region corresponding to the subject in the predetermined state in the captured image.

10. An imaging system comprising an imaging apparatus and an image processing apparatus, wherein
the imaging apparatus includes:
an image sensor that captures a subject image to generate a captured image; and
a transmitter that transmits image data indicating the captured image to the image processing apparatus,
the image processing apparatus includes:
a receiver that receives the image data from the imaging apparatus; and
an image processor that performs, based on the image data received by the receiver, image processing on the captured image indicated by the image data, and
the imaging apparatus or the image processing apparatus includes:
a controller that detects a subject being in a predetermined state, from the captured image, and causes the image processor to perform the image processing to generate a processed image when the subject in the predetermined state is detected, the processed image having an image effect different between an inside and an outside of a subject region corresponding to the subject in the predetermined state in the captured image.
